(19) United States
(12) Patent Application Publication
(10) Pub. No.: US 2010/0075272 A1
(43) Pub. Date: Mar. 25, 2010

(54) HAND HELD APPARATUS FOR CURING MATERIALS

(76) Inventors: Chun-Ta Lin, Taoyuan City (TW); Shan-Non Wang, Jhongli City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/237,608

(22) Filed: Sep. 25, 2008

(51) Int. Cl. A61C 3/00

(52) U.S. Cl. 433/29

(57) ABSTRACT

A hand held apparatus for curing materials with radiation of predetermined wavelength is disclosed. The apparatus includes a housing, a heat sink installed in the housing, a light emitting unit installed on the heat sink, the light emitting unit includes at least one light emitting element, a replaceable heat-dissipating module contacting the heat sink, and a light transmission unit coupled to the housing. The replaceable heat-dissipating module contains liquid for absorbing heat generated from the light emitting unit. The light transmission u nit is used for transmitting the radiation of the light emitting element to the materials. Whereby, the heat dissipation efficiency can be improved.

### BACKGROUND OF THE INVENTION

1. Field of the Invention

The present invention relates to a hand held apparatus, and in particular to a hand held apparatus with a replaceable heat-dissipating module to polymerize the light curable material in medical field.

2. Description of Related Art

Hand held apparatus is wildly used in many applications, for example, the curing hand held apparatus is used to polymerize the curable material in dental practice.

Usually for a curing apparatus of hand held size, at least one curing element for radiating light or heat is installed in the hand held apparatus so that the byproduct of heat is built inside the apparatus to induce damage upon the electronic elements of the apparatus. Conventionally, there is a fan installed inside the apparatus for dissipating heat from the apparatus to the outsize environment via air-flow exchange.

However, when the fan is operating, noises will occur, for example, the sound of airflow or the noise of the rotating fan, therefore, the curing apparatus of hand held size with fan is sometimes not suitable for using in the work place which requires less noises, such as hospital for treatment of noise sensitive patients. Furthermore, the housing of the apparatus has at least one venting hole for airflow, but the apparatus usually needs to be disinfected by using disinfection solution after being used. The disinfection solution may flow into the casing via the venting holes and may easily make the electronic components damage.

Furthermore, the fan of the apparatus consumes electrical power which is supplied by battery or some power supplying systems. Therefore, the users have to replace the battery more often due to this extra energy consumption. The conventional design is not so convenient for the users.

Additionally, the fan assembled inside the hand held apparatus is usually a smaller fan and the cooling efficiency is low, thus the temperature of the curing element is still high. In other words, the efficiency of the traditional cooling fans is in proportion with the size of the fans, the need to fit a fan in side a hand held apparatus naturally constrain the size and the cooling ability of the fan.

Also, if the heat dissipating rate is less than the heat generating rate, the temperature of the curing element will increase to higher than the maximum working temperature. Thus, the operation of the apparatus is interrupted and the doctor or other operator has to stop the treatment and wait for the apparatus to cool.

Therefore, in view of this, the inventor proposes the present invention to overcome the above problems based on his expert experience and deliberate research.

### SUMMARY OF THE INVENTION

The primary object of the present invention provides a hand held apparatus for curing materials with radiation of predetermined wavelength. The hand held apparatus has a replaceable heat-dissipating module thereinside so that a replaceable heat-dissipating module stored with heat can be replaced for a new one. Therefore, the heat-dissipating efficiency of the heat-dissipating unit is improved.

Another object of the present invention is to solve the problems of noise and power consuming of hand held apparatus for curing materials. Furthermore, even if the apparatus is operating at a higher temperature, the replaceable heat-dissipating module can still store the heat generated by the light emitting unit, and if necessary the replaceable heat-dissipating module can be swapped with another replaceable heat-dissipating module so as to reduce down time from heat problems.

In order to achieve the above object, the present invention provides a hand held apparatus for curing materials with radiation of predetermined wavelength, which comprises a housing; a heat sink installed in the housing; a light emitting unit installed on the heat sink; a replaceable heat-dissipating module contacting the heat sink; and a light transmission unit coupled to the housing. The replaceable heat-dissipating module contains liquid for absorbing heat generated front the light emitting unit and a power supply unit is used for providing power for the a light emitting unit. The light transmission unit is used for transmitting the radiation of the light emitting element to the materials.

The present invention provides a hand held apparatus for curing materials with radiation of predetermined wavelength, comprising: a housing; a heat sink installed in the housing; a light emitting unit installed on the heat sink, wherein the light emitting unit comprises at least one light emitting element and a light reflection element, the light reflection element transmits the radiation of the light emitting element to the materials; a replaceable heat-dissipating module contacting the heat sink wherein the heat-dissipating module contains liquid for absorbing heat generated from the light emitting unit; and a power supply unit providing power for the light emitting unit.

In the present invention, the heat-dissipating efficiency is highly improved because the byproduct of heat is stored (i.e. absorbed) within the liquid with high thermal capacity. Moreover, the apparatus of the present invention has no disadvantage of noise and extra power consumption issue.

In order to better understand the characteristics and technical contents of the present invention, a detailed description thereof will be made with reference to the accompanying drawings. However, it should be understood that the drawings and the description are illustrative but not used to limit the scope of the present invention.

### BRIEF DESCRIPTION OF THE DRAWINGS

FIG. 1 is a perspective view showing a first embodiment of a hand held apparatus according to the present invention.

FIG. 2 is a perspective view showing a second embodiment of a hand held apparatus according to the present invention.

FIG. 3A is a schematic representation showing a first assembled structure of a heat sink and a replaceable heat-dissipating module according to the first embodiment of the present invention.

FIG. 3B is a schematic representation showing a second assembled structure of a heat sink and a replaceable heat-dissipating module according to the second embodiment of the present invention.

FIG. 4 is a perspective view showing a third embodiment of a hand held apparatus according to the present invention.

### DETAILED DESCRIPTION OF PREFERRED EMBODIMENTS

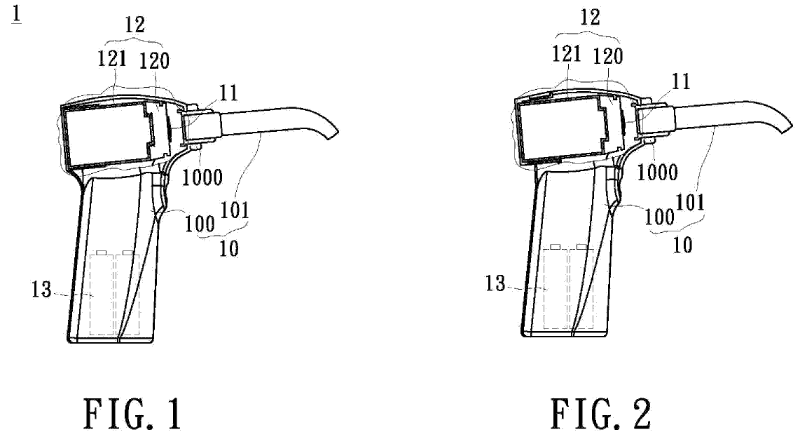

Please refer to FIGS. 1 to 4; the present invention discloses a hand held apparatus which is used for medical treatment application, especially in dental application for curing materials. The hand held apparatus 1 comprises a housing 10, a heat sink 120 and a replaceable heat-dissipating module 121. The housing 10 defines a receiving space for containing components of the apparatus, and these components is described hereinafter. The heat sink 120 is installed inside the housing 10 and the replaceable heat-dissipating module 121 contacts tightly with the heat sink 120. The replaceable heat-dissipating module 121 is used for absorbing heat that is conducted from a light emitting unit 11 through the heat sink 120. In other words, the heat sink 120 and the replaceable heat-dissipating module 121 are constructed as a heat-dissipating unit 12 with high heat-dissipating efficiency. FIG. 1 and FIG. 2 respectively shows a first and a second embodiments and the difference between the two embodiments are the locking means for combining the heat sink 120 and the replaceable heat-dissipating module 121.

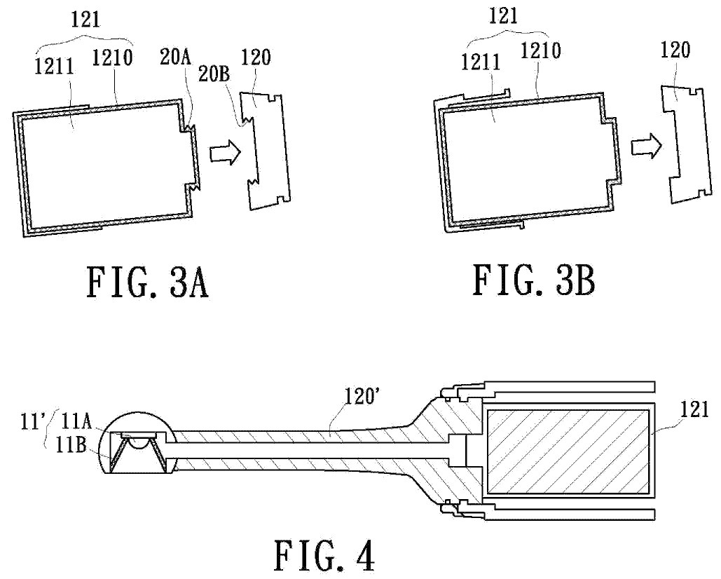

FIGS. 1 and 3A show the first embodiment of the present invention. The replaceable heat-dissipating module 121 has a casing 1210 and liquid 1211 contained inside the casing 1210. The replaceable heat-dissipating module 121 can be drawn out from the heat sink 120 when the liquid 1211 has absorbed heats, and another new replaceable heat-dissipating module 121 can be put into the heat sink 120 for dissipating heat form the light emitting unit 11.

The hand held apparatus 1 provides radiation for curing compound in the embodiment, especially in, but not restricted to dental application. The hand held apparatus 1 is usually used for short period of time. The hand held apparatus 1 has a power supply unit 13 for the light emitting unit 11 and the power supply unit 13 can be batteries or an AC/DC power converter. In other words, the heat-dissipating unit 12 of the present invention is suitable for hand held instrument.

Please refer to FIG. 1 again; the housing 10 of the hand held apparatus 1 has a hand held portion 100 and a light transmission unit 101. The hand held portion 100 has an ergonomic shape for holding and the light transmission unit 101 is substantially a pipe. The hand held portion 100 has an opening 1000 and a side of the light transmission unit 101 connects to the opening 1000. The other side of the light transmission unit 101 is away from the opening 1000. Moreover, the light transmission unit 101 can be a replaceable element and users can choose suitable light transmission unit 101 as desired by the required situations.

The heat sink 120 is installed with the housing 10 and the shape of the heat sink 120 is not restricted. Preferably, the replaceable heat-dissipating module 121 contacts closely to the heat sink 120 and a locking means is formed between the replaceable heat-dissipating module 121 and the heat sink 120. In the embodiment, the replaceable heat-dissipating module 121 is locked on the heat sink 120 so that the wall of the replaceable heat-dissipating module 121 can directly contacts the heat sink 120 for improving the heat-dissipating efficiency.

On the other hand, the casing 1210 of the replaceable heat-dissipating module 121 is made of metal materials with high conductivity and the liquid 1211 contained inside the casing 1210 is materials with high thermal capacity, such as water, saline water, or a mixture of water and antifreeze in order to store/absorb more heat.

The locking means for connecting the replaceable heat-dissipating module 121 with the heat sink 120 is described in detail. Please refer to FIG. 3A; the locking means 20A and 20B is by screw threads. As to FIG. 3B, the locking means 20A and 20B is the clip mechanism at hand held apparatus out casing. The locking means has various types and the locking means is used for connecting the replaceable heat-dissipating module 121 with the heat sink 120.

The hand held apparatus 1 has a light emitting unit 11 for projecting radiation to cure the curable compound. The light emitting unit 11 is installed on the heat sink 120, for example on the outer surface of side wall 1200 of the heat sink 120. The position of the light emitting unit 11 is corresponding to the opening 1000 of the hand held portion 100. The light emitting unit 11 can be a light emitting element, such as a solid state light emitting die or a heat and light generating element. Furthermore, the hand held apparatus 1 has a power supply unit 13 which electrically connects to the light emitting unit 11 to supply the power for operation of the hand held apparatus 1.

The position of the replaceable heat-dissipating module 121 can be adjusted for adapting the hand held apparatus 1 to any application. For example, the replaceable heat-dissipating module 121 can be closed to the light emitting unit 11 for dissipating heat more efficiently.

In usage, the light emitting unit 11 is powered by the power supply of the power supply unit 13 to emit curing light and the light is transmitted to a predetermined curable materials though the light transmission unit 101. Simultaneously, the byproduct of heat is conducted to the replaceable heat-dissipating module 121 though the heat sink 120 and is absorbed within the liquid 1211. After the curable material is cured, the light emitting unit 11 is powered-off. The replaceable heat-dissipating module 121 with stored heat can be drawn out and another replaceable heat-dissipating module 121 for absorbing heat can be connected with the heat sink 120 via locking means.

The replaceable heat-dissipating module 121 with stored heat can be placed under normal air condition for dissipating heat form the liquid 1211 to air. Alternatively, the replaceable heat-dissipating module 121 with stored heat can be placed into a refrigerator to dissipate faster the heat stored in the liquid 1211. Moreover, the housing 10 can have at least one venting hole thereon or not, under the condition that the electronic device inside the housing 10 can operate normally.

FIG. 4 shows a fourth embodiment of the present invention. The difference between this embodiment and the first and second embodiments is that the light emitting unit 11 is a reflective radiation source. The light emitting unit 11′ has a light emitting element 11A and a light reflection element 11B. The light emitting element 11A can be a solid state light emitting die and the light reflection element 11B comprises at least one mirror with optical reflective property or the light reflection element 11B is a reflective plane with a cup shape. The light reflection element 11B is used for reflecting the radiation from the light emitting element 11A to the curable materials. In the embodiment, the heat sink 120′ has a tubular portion and the light emitting element 11A is installed on the end of the tubular portion. Therefore, the light transmission unit 101 is omitted in this embodiment. On the other hand, the replaceable heat-dissipating module 121 is attached or locked on the heat sink 120′. Thus, the hand held apparatus 1 also performs with high dissipating efficiency.

To sum up, the present invention has the following advantages.

1. The present invention provides for an improved heat-dissipating efficiency. The heat is conducted away from the light emitting unit via a solid path, i.e., the heat sink and the casing of the replaceable heat-dissipating module, and the conducted heat is stored within the liquid of high thermal capacity. Therefore the byproduct of heat is dissipated from the light emitting unit so that the performance of the light emitting unit is not affected by the thermal increase.

2. Moreover, it is convenient for easily replacing the replaceable heat-dissipating module. The user can replace the replaceable heat-dissipating module while the hand held apparatus is in non-operating period. In other words, when the hand held apparatus is powered off, the replaceable heat-dissipating nodule with stored heat is replaced by a new one. Therefore, the heat is dissipated and stored within the liquid of the replaceable heat-dissipating module and the new replacement will not interrupt the curing process since it is faster to exchange the replaceable heat-dissipating module as suppose to wait for heat to dissipate on its own.

3. The replaceable heat-dissipating module is used for dissipating heat and the fans of prior art are omitted in the present invention. Therefore, the problems of fans, such as noise of fan operation and electric power consuming are solved.

Even though the present invention has been described with reference to the foregoing preferred embodiment, it shall be understood that the present invention is not limited to the details thereof. Various equivalent variations and modifications may occur to those skilled in this art in view of the teachings of the present invention. Thus, all such variations and equivalent modifications are also embraced within the scope of the present invention as defined in the appended claims.

What is claimed is:

1. A hand held apparatus for curing materials with radiation of predetermined wavelength, comprising:
a housing;
a heat sink installed in the housing;
a light emitting unit installed on the heat sink, the light emitting unit having at least one light emitting element;
a replaceable heat-dissipating module contacting the heat sink, wherein the heat-dissipating module contains liquid for absorbing heat generated from the light emitting unit;
a power supply unit, providing power for the light emitting unit; and
a light transmission unit coupled to the housing for transmitting the radiation of the light emitting element to the materials.

2. The hand held apparatus according to claim 1, wherein the liquid contained within the replaceable heat-dissipating module is water, saline water, or a mixture of water and antifreeze.

3. The hand held apparatus according to claim 1, further comprising a locking means for locking the replaceable heat-dissipating module with the heat sink.

4. The hand held apparatus according to claim 1, wherein the power supply unit is a battery or a power converter.

5. A hand held apparatus for curing materials with radiation of predetermined wavelength, comprising:
a housing;
a heat sink installed in the housing;
a light emitting unit installed on the heat sink, wherein the light emitting unit comprises at least one light emitting element and a light reflection element, the light reflection element transmits the radiation of the light emitting element to the materials;
a replaceable heat-dissipating module contacting the heat sink, wherein the heat-dissipating module contains liquid for absorbing heat generated from the light emitting unit; and
a power supply unit, providing power for the light emitting unit.

6. The hand held apparatus according to claim 5, wherein the liquid contained within the replaceable heat-dissipating module is water, saline water, or a mixture of water and antifreeze.

7. The hand held apparatus according to claim 5, further comprising a locking means for locking the replaceable heat-dissipating module with the heat sink.

8. The hand held apparatus according to claim 5, wherein the power supply unit is a battery or a power converter.

9. The hand held apparatus according to claim 5, wherein the light reflection element comprises at least one mirror with optical reflective property.

10. The hand held apparatus according to claim 5, wherein the light reflection element is a reflective plane with cup shape.
